(19) United States
(12) Patent Application Publication
(10) Pub. No.: US 2007/0272822 A1
(43) Pub. Date: Nov. 29, 2007

(54) Support for a Tire Pressure Sensor

(75) Inventor: Dominique Luce, Bordes de Riviere (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, TOULOUSE CEDEX 1 (FR)

(21) Appl. No.: 11/661,271

(22) PCT Filed: Aug. 24, 2005
(86) PCT No.: PCT/EP05/09126

§ 371 Date: Feb. 27, 2007

(30) Foreign Application Priority Data
Sep. 1, 2004 (FR) 04/09238

(51) Int. Cl. F16M 11/00

(52) U.S. Cl. 248/682

(57) ABSTRACT

This support (6) is designed to receive an electronic module (4) and to be fixed to a rim (2) of a vehicle wheel. It includes a base (16, 18) and elements (10, 12) for fixing the housing (4) to the base. The latter is provided with stiffening elements produced by plastic deformation and suitable for giving this base different radii of curvature.

The present invention relates to a support designed to receive a tire pressure sensor.

It is prior art to equip a car or a heavy truck with a system for monitoring tire pressures. To monitor this pressure, a sensor is installed inside the tire whose pressure is to be monitored. An electronic module is then placed inside the tire and interacts with a central processing unit on board the vehicle so that the driver can be informed about the pressure of its tires. Such tire pressure monitoring systems are known to those skilled in the art and are not described in detail here.

In the prior art, an electronic module is installed inside the tire. This housing of course comprises a pressure sensor. It also comprises means of sending the pressure readings taken to the central processing unit mentioned above, and an energy source, usually a battery, to drive the various components inside the electronic module. The means of transmitting the results of the pressure readings taken comprise a transmitter (usually an LF or low-frequency transmitter operating at about 125 kHz) and also an antenna.

For vehicles equipped with such a system, the electronic module is usually attached to a valve with which each wheel of this vehicle is equipped, this valve being used to introduce air into or release it from the tire and adjust the pressure of the tire.

However, it is also conceivable to place the electronic module containing a pressure sensor no longer on the valve but somewhere on the wheel rim and close to the latter. In some cases it is foreseen to bond a support adhesively to the rim in the well of the rim, that is to say in a peripheral groove usually found in a central position around the periphery of the wheels of cars or heavy trucks.

If the electronic modules are mounted by adhesive bonding on a corresponding wheel rim, a metal cradle is used as the support for attaching the electronic module to the rim. The cradle is bonded to the well of the rim and the electronic module is fixed to this cradle, which is shaped to be able to engage with the housing.

For cost reasons obvious to those skilled in the art, there is a desire to be able to use the same metal cradle for different diameters of wheel rim. Ideally it would be possible to use the same cradle for a 13-inch rim as for a 24-inch rim. The thickness of the adhesive between the rim and the cradle should also be approximately constant. Clearly, therefore, it must be possible to adapt the radius of curvature of the part of the cradle which is to be bonded to the rim.

It is therefore an object of the present invention to provide a housing support structure that will permit adaptation to different diameters of wheel rim.

While it is being bonded, the cradle preferably remains immobile (for example by pressing it against the rim) in order to avoid the peeling effect known to those skilled in the art. This is the effect whereby the component deforms (and therefore debonds) elastically slowly during bonding, thus affecting at least locally the thickness of the adhesive layer and hence the soundness of the bond. To reduce this effect, it is generally advisable to hold the component down during bonding, especially if the radius of curvature of the rim is different from that of the support.

The invention proposes a support designed to receive an electronic module and to be fixed to a rim of a vehicle wheel, comprising a base and means for fixing the housing to the base.

According to this invention, the base is provided with stiffening means produced by plastic deformation and suitable for giving this base different radii of curvature.

Thus, when the base is deformed to give it a particular radius of curvature, the stiffening means maintain this deformation.

Such a support can thus be bonded without elastic deformation occurring during development of the bond. The shape of the support is maintained during the bonding operation, making possible the production of a layer of adhesive of constant thickness and enabling the adhesive to cure properly.

In a preferred embodiment, the base of the support comprises an essentially planar, optionally curved first part, and a second part forming only a single component with the first part and inclined with respect to this first part, and stiffening means are arranged on the second part of the base. In this way it is possible to achieve excellent stiffening of the first part, the second part serving here as the stiffener. In this preferred embodiment, the second part of the base is for example of undulating shape, the undulations extending approximately perpendicularly to the join line between the first and second parts of the base. In this variant, when the first part is curved to match the shape of the rim to which it is to be bonded, the undulating second part reacts like a fan which is pulled open and “remembers” the position given to it.

For even greater stiffness of the support, the support advantageously comprises a third part similar to the second part and arranged approximately symmetrically with respect to the first part of the base.

In another variant, the base comprises for example an essentially planar, optionally curved part with stiffening ribs extending toward the fixing means. These ribs may be additional to or an alternative to the stiffeners described above. They may for example extend approximately parallel to the long sides of the rectangle when the first part is basically rectangular in shape but it is also possible for the ribs to extend essentially in a star-like pattern from the center of the base.

The present invention also relates to a vehicle wheel comprising a rim, characterized in that a support as described above is fixed to the rim by adhesive bonding.

The invention also relates to a method of fixing a pressure sensor to a wheel rim, characterized in that it comprises the following steps:
deforming a support of the kind described above to a template so as to give its base a predetermined radius of curvature,
applying adhesive to the base of the support and/or to the wheel rim,
holding the support on the wheel rim by applying pressure to the support during adhesive curing, and
mounting on the support an electronic module comprising a pressure sensor.

In this method of fixing a pressure sensor, the template used may have for example a radius of curvature smaller than the radius of curvature that is to be produced in the base of the support. It is thus possible to allow for potential springback of the support following its removal from the template.

Various details and advantages of the present invention will become clearer in the course of the following description, which refers to the appended schematic drawing in which:

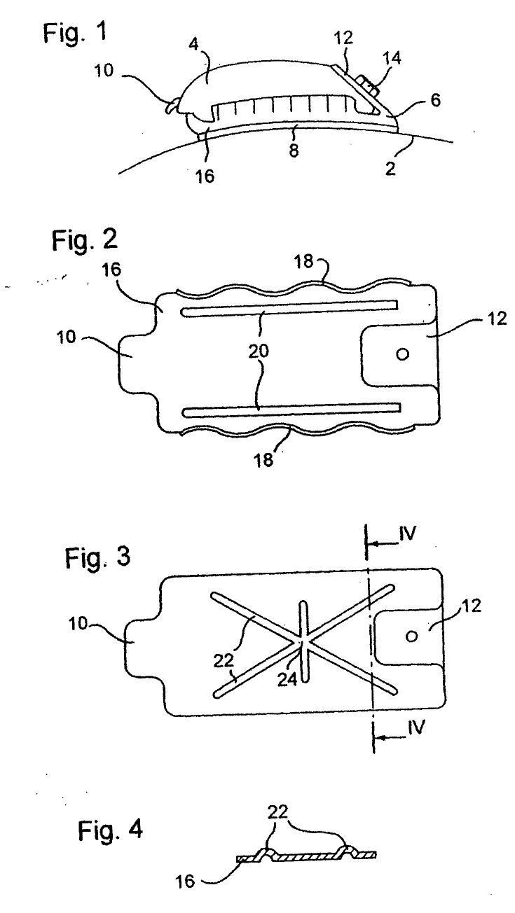

FIG. 1 is a side view of a pressure sensor attached via a support according to the invention to a wheel rim,

FIG. 2 is a top view on a larger scale of the support seen in FIG. 1,

FIG. 3 shows a variant of the support seen in FIG. 2, and

FIG. 4 is a view in cross section on the line marked IV-IV in FIG. 3.

FIG. 1 represents by an arc of a circle a wheel rim 2 of a motor vehicle. The vehicle is equipped with a tire pressure monitoring system. There is thus a pressure sensor inside each wheel of this vehicle. The sensor is placed in an electronic module 4. The latter is mounted on the support 6 in the form of a cradle. The support 6 is held on the wheel rim 2 by a layer of adhesive 8.

The electronic module 4 may be fixed to its support 6 in various different ways. In the embodiment shown in the drawing, the support 6 has a hook 10 and a fixing tab 12. The hook 10, the concavity of which is turned to face the rim 2, may for example engage with a pin (not shown) belonging to the electronic module 4. At the opposite end from the hook 10 and from the corresponding pin of the electronic module 4, the housing is fixed to the fixing tab 12 by for example a screw 14. These means of fixing the electronic module 4 to the support 6 are offered by way of illustrative example and do not imply any limitation.

As indicated above, the support 6 is fixed to the wheel rim 2 by the layer of adhesive 8. As is known to those skilled in the art, for a good bond the layer of adhesive must be homogeneous and of approximately constant thickness. To achieve such a layer of adhesive, the bonding zone of the support 6 must therefore approximately match the shape of the wheel rim 2, at least locally. This part of the support 6, in the form of a curved plane, will be referred to in the remainder of the description as the foot 16.

FIG. 2 is a top view of the support 6 seen in FIG. 1. The foot 16, the hook 10 and the fixing tab 12 are all visible again in this figure. In top view, the foot 16 is roughly rectangular in shape. The presence of two stiffeners 18 will be observed along the two long sides of the foot 16. This is a part of the support 6 that forms only one component with the foot 16 (and with the hook 10 and fixing tab 12 also). The assembly formed by the foot 16 and the stiffeners 18 will be referred to hereinafter as the base of the support 6.

Each stiffener 18 is created by bending in the manner of a fan a part of the metal sheet from which the support 6 is produced. If the foot 16 of the support 6 is assumed to correspond to a cylindrical surface of horizontal axis, the stiffeners 18 are in an approximately vertical plane. The stiffeners 18 are thus approximately perpendicular to the foot 16. The undulations of the stiffeners 18 are formed perpendicular to the join line between the foot 16 and the corresponding stiffener 18.

The presence of two ribs 20 may also be observed in FIG. 2. These ribs 20 project in the same direction as the stiffener 18, i.e. away from the rim 2.

The stiffeners 18 and the ribs 20 give stability of form to the base of the support 6 once the base has been deformed to the radius of curvature of the rim 2 for which the support 6 is intended.

The support 6 is produced by cutting, then drawing and finally bending a metal plate. At the end of these operations the foot 16 of the support 6 may either be planar or its curvature may for example correspond to the curvature of the largest-diameter rim for which the support 6 is intended. The stiffeners 18 and the ribs 20 enable the shape (planar or curved) of the base to be maintained.

The final shaping of the support 6 is performed on an assembly line where the pressure sensor is mounted to its wheel rim. The support 6 is then shaped on a template adapted to the rim 2 to which it will later be bonded. The diameter of the template will not necessarily be the same as the diameter of the wheel rim. The elastic deformations which may occur despite the presence of the stiffeners 18 and ribs 20 must be taken into account. When shaping it on the template, the undulations of the stiffeners 18 open out in the manner of a fan. Large pressure can be applied to the base of the support 6 during this shaping because at this point the electronic module 4 has not yet been mounted on the support 6.

The same support 6 can therefore be used on different types of rim, and for each of them perfect contact can be maintained between the base of the support and the rim owing in particular to the stiffeners 18 and the ribs 20. When bonding, the tensions caused by poor matching of the shape between the two bonded components can thus be eliminated. It is even possible with a support 6 according to the invention to reduce the pressure period during adhesive curing because the base of the support does not have a natural tendency to peel off.

With this novel support concept it is possible to produce a layer of adhesive 8 of constant thickness uniformly distributed between the base of the support and the wheel rim. This also means that there can be a constant distance between the electronic module 4 and the wheel rim 2. This constant distance is favorable to the repeatability of the radiofrequency transmission performance of the electronic module 4, it having been observed on other electronic modules that variation in this distance can cause parasitic phenomena during the transmission and reception of radiofrequency waves.

FIGS. 3 and 4 show a variant of the support 6 seen in FIGS. 1 and 2. In this variant, the support 6 has no stiffener 18. The base is stiffened by ribs 22. These ribs are similar to the ribs 20 of the first embodiment but are arranged in a different way on the base of the support 6. The ribs 22 still project away from the wheel rim 2. The ribs 22 are narrow (about 1 millimeter). They now radiate in a star-like pattern from a central point 24, thus stiffening the base in several directions.

The central point 24 can for example be used for fixing and/or holding the electronic module 4 on the support 6. Clip means may be provided at this central point 4 to engage with complementary clip means formed on the inside face of the electronic module 4. This central fixing of the housing ensures that, when the wheel is turning, the force of gravity acts at the center of the support. By mounting it in this way, the layer of adhesive 8 experiences tensile forces only, not peel forces. The correspondence of shape between the support and the wheel rim is thereby enhanced.

This second embodiment gives substantially the same advantages as those described with reference to the first embodiment shown in FIGS. 1 and 2 and discussed above. Like that first embodiment, this second embodiment of the support provides a support that is simple and cheap to make and that provides mechanical stability over the life of the product.

The present invention is not limited to the embodiments described above by way of non-restrictive examples. It also relates to variants that might be devised by a person skilled in the art within the scope of the following claims.

1. A support (6) designed to receive an electronic module (4) and to be fixed to a rim (2) of a vehicle wheel, comprising a base (16, 18) and means (10, 12) for fixing the housing (4) to the base (16, 18), characterized in that the base is provided with stiffening means (18, 20; 22) produced by plastic deformation and suitable for giving this base different radii of curvature.

2. The support (6) as claimed in claim 1, characterized in that the base of the support (6) comprises an essentially planar, optionally curved first part (16), and a second part (18) forming only a single component with the first part (16) and inclined with respect to this first part (16), and in that stiffening means are arranged on the second part (18) of the base.

3. The support (6) as claimed in claim 2, characterized in that the second part (18) of the base is of undulating shape, the undulations extending approximately perpendicularly to the join line between the first (16) and second (18) parts of the base.

4. The support (6) as claimed in claim 2, characterized in that it comprises a third part (18) similar to the second part (18) and arranged approximately symmetrically with respect to the first part (16) of the base.

5. The support (6) as claimed in claim 1, characterized in that the base comprises an essentially planar, optionally curved part (16) with stiffening ribs (20; 22) extending toward the fixing means (10, 12).

6. The support (6) as claimed in claim 5, characterized in that the base has a roughly rectangular foot (16), and in that the ribs (20) extend approximately parallel to the long sides of the rectangle.

7. The support as claimed in claim 5, characterized in that the ribs (22) extend essentially in a star-like pattern from the center (24) of the base.

8. A vehicle wheel comprising a rim (2), characterized in that a support (6) as claimed in claim 1 is fixed to the rim (2) by adhesive bonding.

9. A method of fixing a pressure sensor to a wheel rim (2), characterized in that it comprises the following steps:
deforming a support (6) as claimed in one of claims claim 1 to a template so as to give its base a predetermined radius of curvature,
applying adhesive to the base of the support and/or to the wheel rim (2),
holding the support (6) on the wheel rim (2) by applying pressure to the support (6) during adhesive curing, and
mounting on the support (6) an electronic module (4) comprising a pressure sensor.

10. The method of fixing a pressure sensor as claimed in claim 9, characterized in that the template has a radius of curvature smaller than the radius of curvature that is to be produced in the base of the support (6).

11. The support (6) as claimed in claim 3, characterized in that the second part (18) of the base is of undulating shape, the undulations extending approximately perpendicularly to the join line between the first (16) and second (18) parts of the base.

12. The support (6) as claimed in claim 2, characterized in that the base comprises an essentially planar, optionally curved part (16) with stiffening ribs (20; 22) extending toward the fixing means (10, 12).

13. The support (6) as claimed in claim 3, characterized in that the base comprises an essentially planar, optionally curved part (16) with stiffening ribs (20; 22) extending toward the fixing means (10, 12).

14. The support (6) as claimed in claim 4, characterized in that the base comprises an essentially planar, optionally curved part (16) with stiffening ribs (20; 22) extending toward the fixing means (10, 12).
